(19) United States
(12) Patent Application Publication
(10) Pub. No.: US 2006/0059741 A1
(43) Pub. Date: Mar. 23, 2006

(54) Illuminated foldable module and display system

(76) Inventor: Robert Landry, Charlesbourg (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/214,926

(22) Filed: Aug. 31, 2005

Related U.S. Application Data
(63) Continuation of application No. PCT/CA04/00327, filed on Mar. 4, 2004.
(60) Provisional application No. 60/451,273, filed on Mar. 4, 2003.

(51) Int. Cl. G09F 1/08

(52) U.S. Cl. 40/540

(57) ABSTRACT

The present invention is a foldable module adapted to be illuminated. The module comprises a foldable panel arranged to be positioned between a folded position and a deployed position. Lights are mounted on the panel and are adapted to lighten the latter and shed light therefrom. It may also have a mechanical system that permits to removably mount a display poster on the panel. The present invention also relates to a method for mounting a display poster on a foldable display system adapted to be illuminated.

### CROSS-REFERENCE TO RELATED APPLICATIONS

This application is a continuation of PCT patent application serial number PCT/CA2004/000327, designating the United States, filed Mar. 4, 2004, the specification of which is hereby incorporated by reference, and claims priority of U.S. provisional patent application 60/451,273 filed on Mar. 4, 2003, the specification of which is hereby incorporated by reference.

### TECHNICAL FIELD

The invention relates to a foldable module adapted to be illuminated and in particular to a foldable module for mounting a transparent display poster thereon and backlightening the latter. It also relates to a method for mounting a display poster on a foldable module in an unfolded state.

### BACKGROUND ART

Nowadays, restricted time and space force us to find solutions that save time, money, and space, Companies are constantly looking for new products which would allow them to get in front of their competitors and highlight their existing products. Among the marketing tools available to the exhibitors, display modules represent certainly a key element of the presentation of companies or of their products to the public. However, the numerous handlings required to travel from an exhibition or a colloquium to another one often limit the exhibitors in the choice of their advertising medium. Therefore, they are interested in light and compact tools. Moreover, the time required to install an advertising medium is frequently a critical variable for the choice of a marketing tool.

Several compact stand systems, which are easy to carry and to install, are presently available. However, these stands offer a limited visual effect because they frequently consist of images on backcloths which require a direct lightening with systems which can damage the visibility by causing unpleasant catch lights.

To reduce these inconveniences, backlightened systems were conceived. Although these systems have the known advantages of attracting the consumer's attention and to avoid unwanted catch lights, these systems are heavy, expensive, and difficult to carry and to install.

Therefore, it would be highly desirable to combine the advantages of compact systems and those of backlightened systems to obtain a support easy to carry and to install.

Furthermore, portable and intense lightening is often needed. The existing systems are expensive, complex and difficult to carry. Moreover, the rigidity of the current lightening systems are not versatile except for the small effects that one can create with a light beam.

### DISCLOSURE OF THE INVENTION

Accordingly, an object of the present invention is to provide a foldable module adapted to be illuminated which can be compacted to facilitate transportation and storage and which can be installed rapidly.

It is another object of the present invention to provide a foldable module adapted to be illuminated on which a display poster can be removably mounted and backlightened.

Yet another object of the present invention is a foldable module adapted to be illuminated which may be easily mass manufactured with well-known and established manufacturing techniques.

Still another object of the present invention is to provide a foldable module adapted to be illuminated that is light, easily transportable and storable.

The present invention is a foldable module adapted to be illuminated. The module comprises: a foldable panel arranged to be positioned between a folded position and a deployed position; means for disposing the panel in the deployed position; lightening means mounted on the panel and adapted to lighten same and shed light therefrom; so constructed and arranged that the panel is arranged in the deployed position when in use and in the folded position when not used.

According to another aspect of the present invention, there is provided a foldable display system for mounting a display poster thereon and lightening same. The display system comprises: a foldable panel arranged to be positioned between a folded position and a deployed position; means for disposing the panel in the deployed position; lightening means mounted on the panel and adapted to lighten same and shed light therefrom; securing means for removably mounting the display poster on the panel; so constructed and arranged that the panel is arranged in the deployed position when in use and in the folded position when not used.

According to another aspect of the present invention, there is provided a method to display a poster. The method comprises: providing a foldable display system in accordance with the invention; positioning the panel in a deployed position; providing a display poster; mounting the poster on the panel in a deployed position using the securing means; providing a power supply for the lightening means; and connecting the lighting means to the power supply.

Another aspect of the invention provides a foldable module adapted to be illuminated. The foldable module comprises: a foldable panel having a folded position for allowing the panel to be stored and transported and a deployed position; at least one light mounted to the panel and adapted to lighten same and shed light therefrom, the at least one light remaining on the foldable panel in the folded and deployed positions.

Another aspect of the invention provides a method to display a poster. The method comprises: providing a foldable display system as described above; positioning the panel in a deployed position; providing a display poster; mounting the display poster on the panel in a deployed position; providing a power supply for the at least one light; and connecting the at least one light to the power supply.

A further aspect of the invention provides a method for lightening an area. The method comprises: providing a foldable module as described above; positioning the panel in the deployed position; providing a power supply for the at least one light; and connecting the at least one light to the power supply.

Another aspect of the invention provides a foldable lighting kit, which comprises: at least two laths articulately connectable to one another and defining, when connected together, a foldable panel movable between a folded position and a deployed position; and at least one light connector mounted to the foldable panel and movable therewith between the folded position and the deployed position.

Another aspect of the invention provides a lighting module, which comprises a rollable panel having at least one light connector mounted thereto and being rollable onto itself for storage and transportation purposes and unwindable in an operative configuration exposing the at least one light connector.

### BRIEF DESCRIPTION OF THE DRAWINGS

These and other features, aspects and advantages of the present invention will become better understood with regard to the following description and accompanying drawings wherein:

FIG. 1 is a front elevation view of a foldable module adapted to be illuminated in accordance with a preferred embodiment of the present invention, wherein a display poster is mounted thereon;

FIG. 2 is a top plan view of the foldable module adapted to be illuminated in accordance with the present invention;

FIG. 3 is a side elevation view of the foldable module adapted to be illuminated in accordance with the present invention with the poster removed;

FIG. 4 is a perspective view, fragmented, of a lath in accordance with the present invention;

FIG. 5 is an alternative hinge mechanism in accordance with the present invention;

FIG. 6 is a side elevation view, enlarged, of a securing system for a display poster on the foldable module adapted to be illuminated in accordance with the present invention;

FIG. 7 is a perspective view of a foldable module adapted to be illuminated in accordance with another embodiment of the present invention;

FIG. 8 is a perspective view of the foldable module in accordance with the other embodiment of the present invention; and

FIG. 9 is a side elevation view of a hinge in accordance with another embodiment of the present invention.

It will be noted that throughout the appended drawings, like features are identified by like reference numerals.

### MODES OF CARRYING OUT THE INVENTION

Embodiments of the invention will now be described with reference to the drawings wherein like numerals refer to like parts.

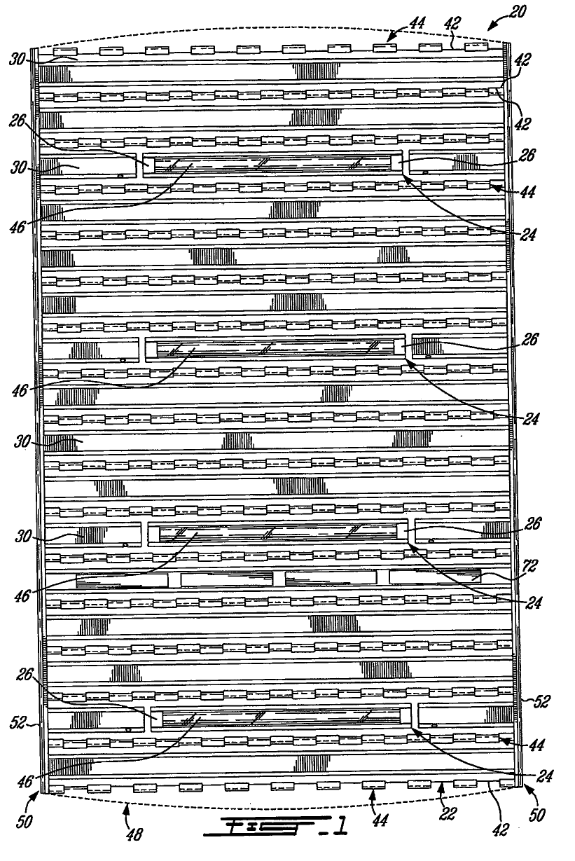

Referring to FIG. 1, it will be seen that foldable module 20 comprises a foldable panel 22 and a lightening system 24 mounted on panel 22 by means of connecting members 26, as it will be described more in details later.

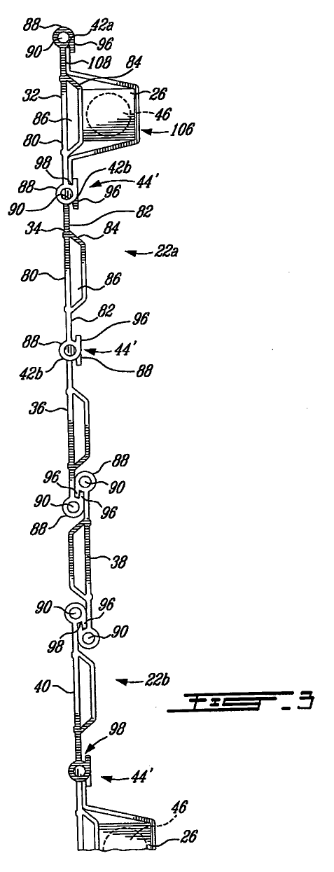

Referring simultaneously to FIGS. 1 and 4, it will be seen that panel 22 consists essentially of a plurality of laths 30 each having two transversal edges 42. At least one transversal edge 42 of lath 30 is juxtaposed to a transversal edge of an adjacent lath 30 and connected thereto by means of hinges 44. Hinges 44 permit both adjacent laths 30 to pivot relatively to one another to allow for the panel to be folded into a compact or folded state to facilitate handling, as it will be described more in detail later. Hinges 44 may be any type of hinge mechanism known to one skilled in the art. Four hinges 44 will be described more in detail later. Laths 30 are assembled to juxtaposed laths 30 with hinges 44 until the desired panel length is achieved. Preferably, hinges 44 are adapted to allow a modification of the length of panel 22 by adding or removing laths 30 in accordance with the user's needs.

Laths 30 are preferably formed from a thin rigid material such as plastic, a sheet metal such as aluminum, or the like. The shape, the material and the dimensions of laths 30 vary in accordance with the user's needs. Typically, laths 30 are made by an extruding or molding process to reduce production costs.

In FIG. 1, lightening system 24 includes fluorescent tubes 46 mounted on laths 30. Depending on the desired effect and the length of panel 22, the number of fluorescent tubes 46 in lightening system 24 may vary.

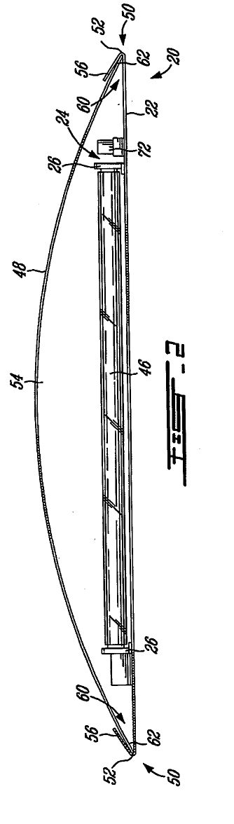

Referring simultaneously to FIGS. 1 and 2, it will be seen that for advertising purposes, foldable module 20 can be transformed into a display system by removably mounting a display poster 48 in front of panel 22. Poster 48 is engaged into a securing member 50 located on two opposite edges 52 of panel 22. Different securing members 50 could be used without departing from the scope of the present invention. Two of them will be described more in detail later.

Poster 48 is preferably manufactured from a flexible material, especially a transparent flexible plastic to allow the light generated by lightening system 24 to go through poster 48. The poster opacity can be adapted in accordance with the desired effect. A more uniform light distribution is obtained with a more opaque material while a higher brightness is obtained with a more transparent poster. One skilled in the art would understand that the advertising messages can be directly written on poster 48 or on another distinct support or advertising medium such as slides (not shown) which are mounted on poster 48 with an adhesive or a fastener.

Referring again simultaneously to FIGS. 1 and 2, it will be seen that poster 48 is preferably wider than panel 22 and adopts an arcuate shape when secured on panel 22 with securing member 50. The arcuate shape creates a space 54 between panel 22 and poster 48 for uniform light dispersion. Lightening system 24, which in the present example includes fluorescent tubes 46, is located in space 54 between panel 22 and poster 48. Space 54 also eliminates heat accumulation resulting from lightening system 24. Preferably, panel 22 and poster 48 have the same height for esthetic reasons.

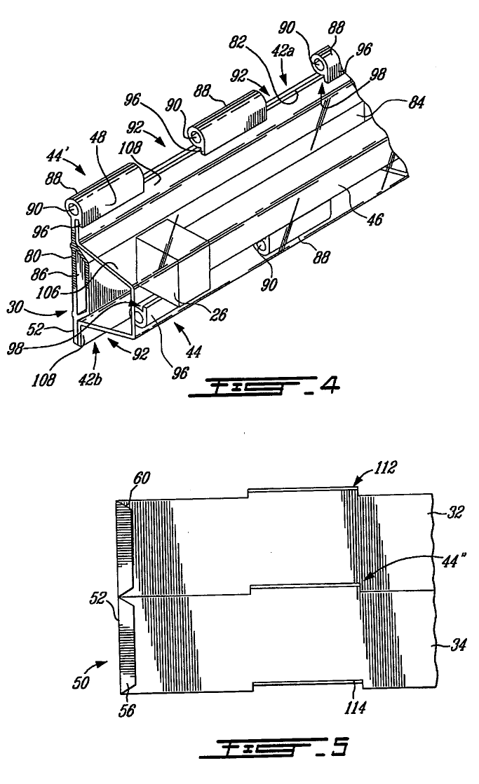

In FIG. 2, securing member 50 consists of two inwardly turned edges 56 located on longitudinal edges 58 of laths 30, which constitute opposite edges 52 of panel 22. The assembly of turned edges 56 and flat portion of lath 30 proximate to turned edge 56 creates a V-shape 60 in which an edge 62 of poster 48 is inserted. Two opposite edges 62 of poster 48 are inserted in opposite V-shapes 60 and are forcedly maintained therein since poster 48 is wider than panel 22 and has an arcuate shape when secured on panel 22. Securing member 50 can be continuous along edges 52 of panel 22 or it can consist in a plurality of V-shapes 60 located on each or several laths 30 along edges 52. As it will be appreciated by one skilled in the art, securing member 50 could be located on any pair of opposite edges 52 of panel 22 without departing from the scope of the invention. Poster 48 can be inserted at one extremity of panel 22 to slide into V-shapes 60 until poster 48 is in the desired position on panel 22. Preferably, as seen of FIG. 5, turned edges 56 have a trapezoidal shape to facilitate the folding of panel 22.

Lightening system 24 includes a starter (not shown), ballasts 72, which are a special sort of transformer, and fluorescent tubes 46. Fluorescent tubes 46 are mounted on laths 30 between two connecting members 26, which are either glued to, welded to, extruded with or fastened to laths 30. Fluorescent tubes 46 are disposed transversally on laths 30 and are either connected in series or in parallel. The starter, ballasts 72, and fluorescent tubes 46 are operatively connected together with wires (not shown). A power cable (not shown) associated with electric outlets (not shown) provides power to lightening system 24. To provide an optimal lightening and allow the module 20 to be easily folded, fluorescent tubes 46 are preferably uniformly disposed on laths 30. For example, a fluorescent tube 46 could be disposed every three laths. A power plug (not shown) for fluorescent tubes 46 is mounted inwardly on each connecting member 26 and is operatively connected to the wire. Pins (not shown) of fluorescent tubes 46 are inserted into the power plugs for electrical contact and mounting fluorescent tube 46 on panel 22. It would be understood by someone skilled in the art that fluorescent tubes 46 could be disposed at a narrower or wider interval without departing from the scope of the present invention and that the starter and ballasts 72 could be positioned anywhere either on the panel or on a separate member. Moreover, lightening system 24 can be provided with more than one starter or with bulbs (not shown) instead of fluorescent tubes 46.

FIGS. 3 and 4 show a first hinge 44′ that allows a first lath 32 to pivot relatively to a second lath 34 juxtaposed to lath 32. Similarly, laths 34 and 36 pivot together and the two hinges 44′ being identical, only one will be described in details, i.e. the one connecting laths 32 and 34. It will be seen that laths 32, 34, 36, 38, and 40 have a flat back surface 80, a front surface 82 with a protruding member 84 having a channel 86 therein, and two transversal edges 42a, 42b with hinge members 88 extending therefrom. Hinge members 88 have a bore 90 extending transversally thereinto. Channel 86 inside protruding member 84 is used to hide the wires of lightening system 24. The wires can then provide power to lightening system 24 without being seen from the user while reducing the probabilities of wire damaging. Connecting members 26 for fluorescent tubes 46 are disposed on protruding member 84. A plurality of hinge members 88 are disposed alternatively on both transversal edges 42a, 42b of laths 32, 34. Hinge members 88 on laths 32 and 34 are identical, and therefore only one will be described. Along a transversal edge 42a, each hinge member 88 is separated from the nearest hinge member 88 by a hollow space 92. Therefore, hinge member 88 and hollow space 92 alternate on transversal edge 42a. Preferably, hinge member 88 and hollow space 92 have the same length. On the opposite transversal edge 42b, hinge members 88 and hollow space 92 are disposed in a similar alternate manner. However, a hinge member 88 on transversal edge 42a faces a hollow space 92 on transversal edge 42b and vice-versa. Laths 32, 34 are assembled by inserting a hinge member 88 of lath 32 into a hollow space 92 of lath 34 and vice-versa. Bores 90 of hinge members 88 on transversal edge 42b of lath 32 face bores 90 of hinge members 88 on transversal edge 42a of lath 34 juxtaposed to lath 32 and form a continuous channel in which a rod (not shown) is inserted. The rod maintains laths 32, 34 together and allows a pivoting movement of both laths 32, 34 relatively to one another. Hinge 44′ can be located either all along or on a portion only of transversal edges 42a, 42b of laths 32, 34, 36, 38, and 40.

Also, hinge member 88 has a tooth 96 extending inwardly therefrom toward the center of lath 30. The combination of tooth 96, hinge member 88, and front surface 82 forms a hook 98. Hook 98 can be used to join two panels 22a, 22b together. Referring to FIG. 3, it will be seen that panel 22a having a end lath 36 is joined to panel 22b having a end lath 40 through lath 38. Lath 38 is positioned between laths 36 and 40 and in the opposite direction in a manner such that hooks 88 of juxtaposed transversal edges 42 of laths 36 and 38 are inserted into each other and, similarly, hooks 98 of juxtaposed transversal edges 42 of laths 38 and 40 are inserted into each other and maintain panel 22a and 22b together. Hooks 98 allow to easily and rapidly modify the length of module 20.

Still referring to FIGS. 3 and 4, a protection member 106 is positioned over fluorescent tube 46 to prevent breakages while manipulating module 20. Protection member 106 consists of a rigid transparent plastic having a trapezoidal shape mounted on a lath 30 over fluorescent tube 46. Edges 108 of protection member 106 are inserted into hooks 98 of laths 30. The shape (trapezoidal, semi-circular, square, etc), the material and mounting method (fastened, glued, inserted, engaged, etc.) of protection member 106 could be modified without departing from the scope of the invention.

FIG. 5 shows a hinge 44″ that allows a first lath 32 to pivot relatively to a second lath 34 juxtaposed to lath 32. Hinge 44″ consists of a J-shape member 112 protruding from a first transversal edge 42a and a recess 114 having a protruding hook portion (not shown) located on the second transversal edge 42b, opposite to transversal edge 42a. J-shape member 112 and recess 114 face each other. To assemble laths 32 and 34, J-shape member 112 of lath 34 is inserted into the hook portion of recess 114 of lath 32. To obtain an adequate lath assembly, transversal edges 42 of laths 32, 34 have preferably more than one hinge 44″.

Hinge 44 could also consist of a J-shape member 112 protruding from a first transversal edge 42a and a slot (not shown) located above the second transversal edge 42b and below J-shape member 112. This will allow J-shape member 112 of lath 34 to be inserted into the slot of a second lath 32 juxtaposed to lath 34 when laths 32, 34 are assembled together. As for hinge 44″, to obtain an adequate lath assembly, laths 32, 34 have preferably more than one hinge 44. Hinge 44 could also consist of at least one plastic band (not shown) mounted longitudinally on laths 30. The plastic band is used to assemble laths 30 together and allows panel 22 to be in either a folded state or a deployed state by permitting a pivoting movement of laths 30 relatively to one another.

Referring now to FIG. 6, it will be seen that an alternative securing member 50′ for poster 48 can be used to engage one longitudinal edge 52 of panel 22 over laths 30. Securing member 50′ has an engaging portion 120 that is engaged over edge 52 and a clamp 122 that has a narrow groove 124 therein in which edge 62 of poster 48 is inserted. The orientation of clamp 122 relatively to engaging portion 120 determines the curvature of poster 48. If securing member 50′ is continuous along edge 52 of panel 22 and is engaged with laths 30, perpendicularly to the latter, securing member 50′ stiffens panel 22 in a deployed state. Securing members 50′ have to be removed from edges 52 of panel 22 before moving panel 22 between a deployed state to a folded state. Any other securing member such as an adhesive or mechanical fasteners could be used for mounting poster 48 on panel 22 without departing from the scope of the present invention.

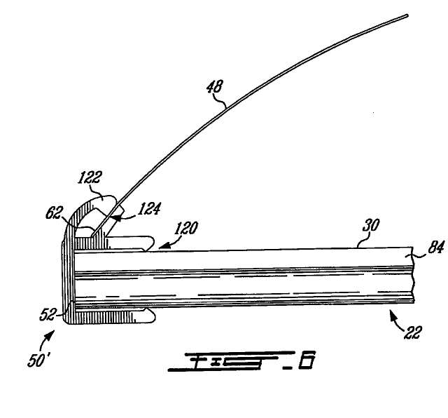

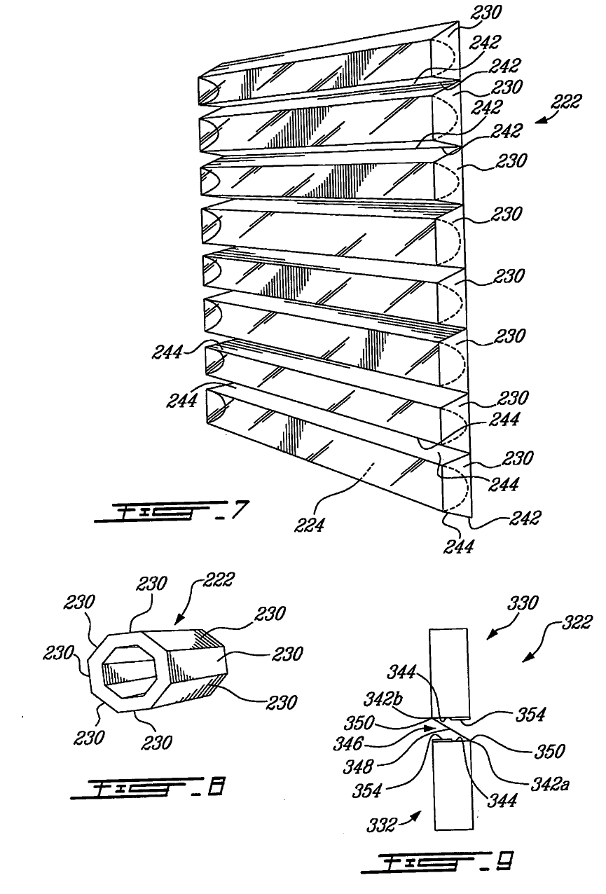

Referring to FIG. 7, it will be seen that, in another embodiment of the invention, a foldable panel 222 includes a plurality of lath members 230. As for panel 22 each panel 222 has two transversal edges 242 and at least one transversal edge 242 of lath 230 member is juxtaposed to a transversal edge 242 of an adjacent lath 230 and connected thereto by means of hinges (not shown). The hinges permit both adjacent laths 230 to pivot relatively to one another to allow for the panel to be folded into a compact or folded state, as shown in FIG. 8, to facilitate handling. Lath members 230 have two transversal lateral edge surfaces 244 that are inwardly beveled to facilitate the folding of panel 222. Lightening system 224 is disposed into lath members 230 and provides illumination therein and shed light therefrom.

Referring now to FIG. 9, it will be seen that, in another embodiment of the invention, a foldable panel 322 includes a plurality of lath members 330, 332. As for panel 222, lath members 330, 332 have two transversal lateral edge surfaces 344 that are connected to each other by means of a hinge 346. Hinge 346 consists of a plate 348 having a first edge 350 pivotally connected to a transversal edge 342a of lateral edge surface 344 of lath 332 and a second edge 352 pivotally connected to a transversal edge 342b of lateral edge surface 344 of lath 330. Transversal edges 342a, 342b are opposite to each other, therefore, plate 348 is diagonally disposed between laths 330, 332. Both lateral edge surfaces 344 have a magnet 354 mounted thereon. Magnets 354 of laths 330, 332 are attracted to each other and therefore strengthen panel 322 in the unfolded position.

Module 20 is adapted to be disposed either on a stand or on a wall. Therefore, eyelets (not shown) or any other appropriate fastening equipment that can be used to dispose panel 22 on a wall can be mounted on panel 22. If a stand is used, the panel is self-supporting when deployed. The stand is preferably demountable, compact and light, to facilitate its transportation with the module.

A person skilled in the art will appreciate that the foldable module 20 can be used as a light source in several applications. For example, without being limitative, it can be used in photography for providing a transportable light source which light intensity can be easily adjusted. It can also be used in greenhouses as an adjustable light source.

It will be understood that numerous modifications thereto will appear to those skilled in the art. For instance, the panel could have more than one fluorescent or bulb on a lath. The panel could be a single piece of plastic on which a lightening system is mounted and that can be folded when not used and deployed when in use. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A foldable module adapted to be illuminated, said foldable module comprising:
a foldable panel having a folded position for allowing said panel to be stored and transported and a deployed position;
at least one light mounted to said panel and adapted to lighten same and shed light therefrom, said at least one light remaining on said foldable panel in said folded and deployed positions.

2. A foldable module in accordance with claim 1, wherein the panel comprises:
a plurality of laths, each lath having two transversal edges, at least one transversal edge of one lath being juxtaposed to a transversal edge of an adjacent lath; and
at least one hinge connecting the juxtaposed edges of two adjacent laths and allowing the laths to articulate relative to one another so as to position the panel in one of the folded position and the deployed positions.

3. A foldable module in accordance with claim 2, wherein the number of laths is selected to obtain a panel with a predetermined length.

4. A foldable module in accordance with claim 1, comprising at least one light connector mounted to one side of the panel for mounting the at least one light thereto.

5. A foldable module in accordance with claim 2, wherein the at least one hinge comprises at least one hinge member having a bore therein on each adjacent lath, the hinge member of the adjacent laths being interconnected with at least one rod inserted in the bores of the hinge members and adapted to allow transversal rotation of one lath relatively to one another.

6. A foldable module in accordance with claim 3, wherein the at least one hinge comprises at least one protruding member disposed on one of the transversal edges and a corresponding groove located on the juxtaposed transversal edge of an adjacent lath, the protruding member being adapted to be inserted into the groove to allow transversal rotation of one lath relatively to one another.

7. A foldable module in accordance with claim 1, comprising at least one display poster connector for removably mounting a display poster on the panel in the deployed position.

8. A foldable module in accordance with claim 7, wherein said at least one light is positioned between the panel and the display poster.

9. A foldable module in accordance with claim 1, comprising at least one protection member mounted over said at least one light.

10. A foldable module in accordance with claim 2, wherein the at least one of the laths is light equipped and at least one of the laths is light free.

11. A foldable module in accordance with claim 7, wherein the at least one display poster connector is adapted to provide the display poster with an arcuate shape when mounted on the panel, the arcuate shape creating a space between the panel and the display poster for light dispersion.

12. A method to display a poster, comprising:
providing a foldable display system in accordance with claim 1;
positioning the panel in a deployed position;
providing a display poster;
mounting the display poster on the panel in a deployed position;
providing a power supply for said at least one light; and
connecting said at least one light to the power supply.

13. A method for lightening an area, comprising:
providing a foldable module in accordance with claim 1;
positioning the panel in the deployed position;
providing a power supply for the at least one light; and
connecting the at least one light to the power supply.

14. A method in accordance with claim 13, wherein the panel comprises a plurality of laths pivotally connected to one another, the method comprising the step of: adjusting lightening intensity by one of connecting to the panel at least one lath having at least one light mounted thereto and disconnecting from the panel at least one lath having at least one of the at least one light mounted thereto.

15. A method in accordance with claim 13, wherein the panel comprises a plurality of laths pivotally connected to one another, the method comprising the step of: adjusting the length of the panel by one of connecting to the panel at least one lath and disconnecting from the panel at least one lath.

16. A foldable lighting kit, comprising:
at least two laths articulately connectable to one another and defining, when connected together, a foldable panel movable between a folded position and a deployed position; and
at least one light connector mounted to the foldable panel and movable therewith between the folded position and the deployed position.

17. A foldable lighting kit in accordance with claim 16, wherein each one of the at least two laths comprises a first edge and a second edge, opposed to the first edge, the first edge of a first lath being articulately connectable to the second edge of a second lath to define the foldable panel.

18. A foldable lighting kit in accordance with claim 16, comprising at least one display poster connector for removably mounting a display poster to the folded panel in the deployed position.

19. A foldable lighting kit in accordance with claim 16, comprising at least one light equipped lath and at least one light free lath.

20. A lighting module comprising a rollable panel having at least one light connector mounted thereto and being rollable onto itself for storage and transportation purposes and unwindable in an operative configuration exposing the at least one light connector.

21. A lighting module in accordance with claim 20, wherein the rollable panel comprises a plurality of laths pivotally connected to one another.

22. A lighting module in accordance with claim 21, wherein the laths are removably connected to one another.

23. A lighting module in accordance with claim 21, wherein at least one of the at least one light connector is mounted to one of the laths and at least one of the laths is light connector free.

24. A lighting module in accordance with claim 20, wherein each one of the laths comprises a first edge and a second edge, opposed to the first edge, the first edge of a first lath being pivotally connected to the second edge of a second lath to define the rollable panel.

25. A lighting module in accordance with claim 20, comprising at least one display poster connector for removably mounting a display poster to the rollable panel in the operative configuration.
